(19) United States
(12) Patent Application Publication
(10) Pub. No.: US 2009/0019322 A1
(43) Pub. Date: Jan. 15, 2009

(54) Production Line Control System

(75) Inventors: Tomofumi Sekiyama, Saitama (JP); Kazuhiko Ogawa, Saitama (JP); Yuichi Makino, Saitama (JP)

Correspondence Address: STANDLEY LAW GROUP LLP, 495 METRO PLACE SOUTH, SUITE 210, DUBLIN, OH, 43017, US

(73) Assignee: Honda Motor Co., Ltd., Tokyo (JP)

(21) Appl. No.: 11/573,115

(22) PCT Filed: May 31, 2006
(86) PCT No.: PCT/JP2006/311353

§ 371 Date: Feb. 2, 2007

(30) Foreign Application Priority Data
Jun. 7, 2005 (JP) 2005-166853

(51) Int. Cl. G06F 11/32; G06F 19/00

(52) U.S. Cl. 714/55; 700/108; 714/E11.187

(57) ABSTRACT

A production line control system (10) comprising a support personnel call device (PB1, PB2, PB3, PB4) for a worker (M1, M2, M3, M4) to call for support personnel (H1, H2); a time-counting device (12) for operating when a call signal (I1, I2, I3, I4) is obtained; and a central control (13) for generating a line-stopping signal (L) when an elapsed time (Tact) of the time-counting device exceeds a predetermined control time (Tm).

### TECHNICAL FIELD

The present invention relates to a control system used for a production line and for workers positioned along the production line when the workers carry out prescribed actions on workpieces that are conveyed by the production line.

### BACKGROUND ART

Workers positioned along a production line may attach components or perform other prescribed actions on workpieces that are conveyed by the production line. Specifically, workers supervise a certain step and finish a prescribed task within an appointed time period. However, in some instances the task cannot be finished within the appointed time period due to a variety of reasons and circumstances. As a counter-measure, systems such as shown in JP-B 2766215, for example, have been proposed to resolve malfunctions by calling in support personnel.

The following takes place with this system: When production equipment in a factory malfunctions, a first worker performs a repair operation. However, when the first worker does not have the necessary repair training and must call for assistance, the first worker pushes a button switch of a portable computer terminal according to the type of malfunction occurring in the production equipment, and electromagnetic waves are emitted from the portable computer terminal. The emitted electromagnetic waves are received by a receiver device used with the portable computer terminal. The received electromagnetic waves are transferred to a wireless transceiver device used for communication with a base station. Electromagnetic waves are then emitted therefrom to a wireless base station transceiver device. A judgment is made that the first worker requires assistance using a control console that has received the electromagnetic waves, and a second worker is called out.

However, if the second worker is performing another urgent procedure, the first worker's call may not be immediately addressed, and the malfunction will not be able to be resolved.

Even when the second worker is able to respond immediately to the call, the recovery will be time-consuming if the production equipment has a major malfunction. When recovery is time-consuming, a judgment must be made as to whether or not to stop the production line.

Accordingly, a demand has arisen for a control system to stop the production line based on set conditions, including when the second worker cannot respond to a call, and even when neither the first worker nor the second worker can decide to stop the line.

### DISCLOSURE OF THE INVENTION

According to the present invention, there is provided a production line control system that is used for a production line and for a worker positioned along the production line when the worker carries out a prescribed action on a workpiece that is conveyed by the production line, the control system comprising a support personnel call device to be operated when the worker calls for support personnel; a time-counting device for beginning to count elapsed time at a point when a call signal is obtained from the support personnel call device; and a central control for acquiring the elapsed time from the time-counting device and performing control to stop the line when the elapsed time exceeds a predetermined control time.

A function is included in the central control for automatically generating a line-stopping signal when the time elapsed after the call for support personnel exceeds the control time. A line-stopping process is automatically performed by the central control in addition to emergency stop processes performed by the workers, support personnel, or other personnel.

Specifically, the production line is automatically stopped based on set conditions, including when support personnel cannot respond to a call, even when neither the workers nor the support personnel can decide to stop the line.

Preferably, a portable information terminal is provided for transmitting the condition of the production line to the central control, and information about the malfunction of the production line is sent to the central control from the portable information terminal.

Support personnel will be more likely to be better able to calmly assess the malfunction in the production line than the workers. Accordingly, support personnel are apprised of the situation and made to send the information to the central control.

Preferably, a display is provided in the vicinity of the production line for acquiring information from the central control and displaying the information about the malfunction and a corresponding step.

It shall be apparent that the worker who calls the support personnel can inform the support personnel, the other workers, and other personnel of the condition of the production line and can alert everyone about the possibility of line stoppage and provide advance notice. Recovery measures can then be worked out by a plurality of workers and support personnel, and the production line can be repaired more quickly.

### BRIEF DESCRIPTION OF THE DRAWINGS

FIG. 1 is a block diagram of a production line control system according to the present invention;

FIG. 2 is a plan view of a support personnel call device included in the production line control system; and

FIG. 3 is a control flowchart of the production line control system according to the present invention.

### BEST MODE FOR CARRYING OUT THE INVENTION

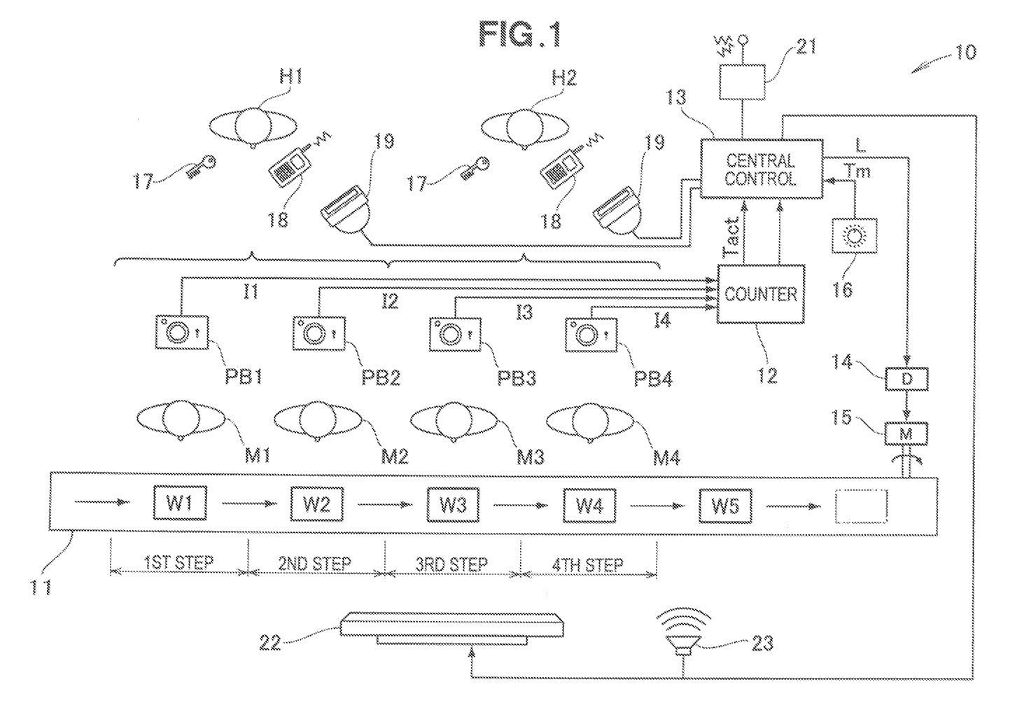

As shown in FIG. 1, a control system 10 for a production line comprises the following: support personnel call devices PB1 through PB4, to be operated when workers M1, M2, M3, M4 who work on a continuous conveyer or other part of a production line 11 call for support personnel H1, H2; a time-counting device 12 for beginning to count elapsed time at a point when at least one call signal 11 through 14 is obtained from the support personnel call devices PB1 through PB4; and a central control 13 for acquiring the elapsed time Tact from the time-counting device 12 and generating a line-stopping signal L when the elapsed time Tact exceeds a predetermined control time Tm.

A workpiece W1 is subjected to the process relating to the relevant step to become a workpiece W2, and the workpiece W2 is subjected to the process relating to the relevant step to become a workpiece W3. This continues in the same manner so that the workpiece W3 becomes W4 and then W5, and gradually reaches ever higher degrees of completion. The workpieces W1 through W5 may be vehicles, for example.

The line-stopping signal L generated by the central control 13 is transmitted to a motor driver 14, and the motor driver 14 stops a motor 15. The production line 11 is thereby stopped.

The control time Tm can be arbitrarily set by a control-time setting device 16.

Along the flow of workpieces W1 through W4 on the operation line 11, a first step, a second step, a third step, and the like are allocated according to the nature of the associated task. Workers M1, M2, M3, and the like are assigned to each of these steps. Also, a single support person H1 is assigned to each of a plurality of workers M1.

In other words, the workers are designated M1, M2, M3, M4 and the support personnel are designated H1, H2, but the numbers thereof are arbitrary.

The support person H1 possesses a portable information terminal 18, a monitor 19, and a unique key 17 that acts as a counter canceling device for use when canceling the counting operation of the time-counting device 12. The support person H2 is similarly equipped.

Information dispatched by the portable information terminal 18 is transmitted to the central control 13 via a wireless receiver 21.

Further, a large-scale display or other display 22 is positioned in the vicinity of the production line 11, and specifically in a location visible to all of the workers M1, M2, M3, M4. The information displayed on the display 22 is generated by the central control 13. Specific display images will be described hereunder. Symbol 23 designates a voice generator that broadcasts music and issues alerts according to the situation.

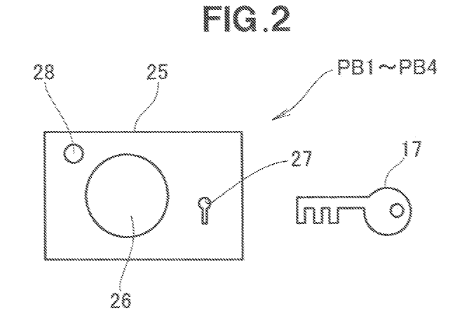

Next, the configuration of the support personnel call device will be described in detail based on FIG. 2. The support personnel call devices PB1 through PB4 are provided with a box 25, a red button 26, a key hole 27, and an operation lamp 28, as shown in FIG. 2.

The devices PB1 through PB4 are enabled when the operation lamp 28 is lit up. Pushing the red button 26 will call support personnel. When the red button 26 is pushed, the time count begins, but if the unique key 17 is inserted into the key hole 27 and turned, the time count stops. The structure and format of the support personnel call devices PB1 through PB4 may be changed as required, and may even have a lever switch instead of a push-button.

Next, sample displays produced by the display 22 shown in FIG. 1 will be described based on Tables 1 through 5 shown below. Each table is shown in full on the display 22.

TABLE 1

| | 1^{st} Column | 2^{nd} Column | 3^{rd} Column | 4^{th} Column |
|---|---|---|---|---|
| 1^{st} Row | 1^{st} Step | Normal | | |
| 2^{nd} Row | 2^{nd} Step | Normal | | |
| 3^{rd} Row | 3^{rd} Step | Normal | | |
| • | • | • | | |

TABLE 2

| | 1^{st} Column | 2^{nd} Column | 3^{rd} Column | 4^{th} Column |
|---|---|---|---|---|
| 1^{st} Row | 1^{st} Step | Normal | | |
| 2^{nd} Row | 2^{nd} Step | Abnormal | XX min. | |
| | | | before line | |
| | | | stoppage | |
| 3^{rd} Row | 3^{rd} Step | Normal | | |
| • | • | • | | |

TABLE 3

| | 1^{st} Column | 2^{nd} Column | 3^{rd} Column | 4^{th} Column |
|---|---|---|---|---|
| 1^{st} Row | 1^{st} Step | Normal | | |
| 2^{nd} Row | 2^{nd} Step | Abnormal | YY min. | Tool damage: |
| | | | before line | replacement |
| | | | stoppage | needed |
| 3^{rd} Row | 3^{rd} Step | Normal | | |
| • | • | • | | |

TABLE 4

| | 1^{st} Column | 2^{nd} Column | 3^{rd} Column | 4^{th} Column |
|---|---|---|---|---|
| 1^{st} Row | 1^{st} Step | Normal | | |
| 2^{nd} Row | 2^{nd} Step | Normal | Time count | |
| | | | cancelled | |
| 3^{rd} Row | 3^{rd} Step | Normal | | |
| • | • | • | | |

TABLE 5

| | 1^{st} Column | 2^{nd} Column | 3^{rd} Column | 4^{th} Column |
|---|---|---|---|---|
| 1^{st} Row | 1^{st} Step | Normal | | |
| 2^{nd} Row | 2^{nd} Step | Abnormal | Line | Tool damage: |
| | | | stopped | Replacement |
| | | | | needed |
| 3^{rd} Row | 3^{rd} Step | Normal | | |
| • | • | • | | |

As shown in Table 1, the steps are allocated on the display 22, with, e.g., the first, second, and other steps shown in the first column. The second column shows whether the function is normal or abnormal.

Provisionally, when a worker of the second step operates the support personnel call device, “abnormal” is displayed in the second row, second column, as shown in Table 2. The display “abnormal” will flash. Additionally, the time until line stoppage (remaining time) is displayed in the second row, third column.

When the support personnel has understood the situation and sent information about the malfunction to the central control, “tool damaged,” “replacement required,” or other information about the malfunction will be displayed in the second row, fourth column, as shown in Table 3.

When the assistance provided by the support personnel is successful and the time count is cancelled according to a prescribed procedure, the fact that the time count was cancelled is displayed in the second row, third column, as shown in Table 4. The second row, fourth column becomes blank, and the display of “abnormal” in the second row, second column is returned to a normal display.

When the assistance provided by the support personnel is not successful and the elapsed time has exceeded the control time, “line stopped” is displayed in the second row, third column, as shown in Table 5. This display will flash.

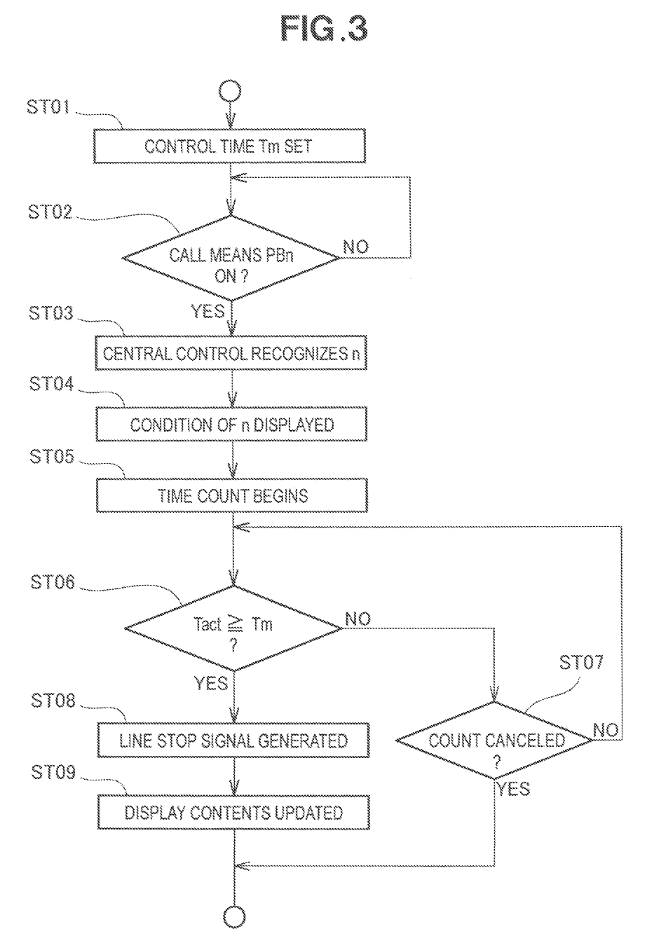

The control operation of the production line control system described above will be explained based on the flow chart shown in FIG. 3, with reference to FIG. 1.

In step (abbreviated as ST below) 01, the control time Tm is set in the central control 13 by using the control time setting device 16. At this point, the contents of Table 1 are displayed on the display 22.

In ST02, the central control 13 checks whether or not the support personnel call device PBn (n=step number 1, 2 . . . m) is on. If the production line is functioning normally, a NO is received and nothing further is done. If a YES is received in ST02, then in ST03 the central control 13 recognizes the called-in step number n.

In ST04, the central control 13 displays the contents of Table 2 on the display 22.

In ST05, the time-counting device 12 begins the time count.

Next, when support personnel H1, H2 (FIG. 1) understand the condition of the malfunction and wirelessly transmit the information to the central control, the central control changes the display to the contents of Table 3.

In ST06, the central control 13 checks whether or not the elapsed time (Tact) has reached the control time Tm. If NO, the process moves to ST07.

In ST07, a check is made as to whether or not the support personnel call device PBn is still on. Specifically, a check is made as whether or not the time count has been cancelled. If the time count has been cancelled, control flow is ended and the contents of Table 4 are displayed on the display 22.

If a YES is received in ST06, the process moves to ST08. The central control 13 generates a line-stop signal and the production line is stopped. This measure is based on the time count not having been cancelled at the point when the elapsed time Tact reaches the control time Tm.

In ST09, the contents of Table 5 are displayed on the display 22.

The control system for a production line having the configuration and operation above can be summarized as follows.

In FIG. 1, the production line control system 10 is characterized in comprising support personnel call devices PB1 through PB4, to be operated when workers M1 through M4, who work on a production line 11, call for support personnel H1, H2; a time-counting device 12 for beginning to count elapsed time at a point when a call signal is obtained from the support personnel call devices PB1 through PB4; and a central control 13 for acquiring the elapsed time from the time-counting device 12 and generating a line-stopping signal when the elapsed time exceeds a predetermined control time.

Specifically, a function is included in the central control 13 for automatically generating a line-stopping signal when the time elapsed after the call for support personnel exceeds the control time. Overall control of the production line can be properly maintained because a line-stopping procedure is automatically performed by the central control; and emergency stop procedures are performed by the workers M1 through M4, the support personnel H1, H2, or other personnel.

Another characteristic is the provision of a portable information terminal 18 for transmitting the condition of the production line 11 to the central control 13, and the ability of the support personnel H1, H2 to send information on malfunctioning of the production line 11 to the central control 13 by using the portable information terminal 18.

Specifically, the support personnel H1, H2 can send information on malfunctioning of the production line 11 to the central control 13 by using the portable information terminal 18.

The support personnel H1, H2 are very likely to be better able to calmly assess the malfunction of the production line 11 than the workers M1 through M4. In such instances, the support personnel H1, H2 are apprised of the situation and send that information to the central control 13. As a result, control can be performed more reliably.

Further, the display 22, which displays the information about the malfunction and the corresponding steps, is positioned in the vicinity of the production line 11. It shall be apparent that the worker (M1, for example) who calls the support personnel H1, H2 can inform the support personnel H1, H2, the other workers (M2 through M4, for example), and other personnel of the condition of the production line 11 and can alert everyone with information such as noting the possibility of stopping the line or giving advance notice. Recovery measures can then be worked out by a plurality of workers M1 through M4 and support personnel H1, H2; and the production line can be repaired more quickly.

Vehicles are ideal as the workpiece in the present invention. However, the production line control system of the present invention may be provided for production lines for all kinds of products other than vehicles.

### INDUSTRIAL APPLICABILITY

As described above, the production line control system according to the present invention is particularly useful for vehicle production lines.

1. A production line control system that is used for a production line and for a worker positioned along the production line when the worker carries out a prescribed action on a workpiece that is conveyed by the production line, said control system comprising:
a support personnel call device to be operated when the worker calls for support personnel;
a time-counting device for beginning to count elapsed time at a point when a call signal is obtained from the support personnel call device; and
a central control for acquiring the elapsed time from the time-counting device and performing control to stop the line when the elapsed time exceeds a predetermined control time.

2. The control system of claim 1, further comprising a portable information terminal for transmitting a condition of the production line to the central control, wherein information on a malfunction of the production line is sent to the central control from the portable information terminal.

3. The control system of claim 2, further comprising a display, provided closely to the production line, for acquiring information from the central control and displaying the information the malfunction and a corresponding step.
